(19) United States
(12) Patent Application Publication
(10) Pub. No.: US 2010/0285710 A1
(43) Pub. Date: Nov. 11, 2010

(54) SKIS AND THE LIKE WAXED WITH PTFE- CONTAINING, NEAR SUPER-HYDROPHOBIC WAX COMPOSITION AND COMPOSITION, PROCESS AND KIT FOR ITS PRODUCTION

(75) Inventor: Franklin G. Reick, Mahwah, NJ (US)

Correspondence Address: MILLEN, WHITE, ZELANO & BRANIGAN, P.C., 2200 CLARENDON BLVD., SUITE 1400, ARLINGTON, VA, 22201, US

(73) Assignee: BRIAREOS, INC., MAHWAH, NJ (US)

(21) Appl. No.: 12/740,449

(22) PCT Filed: Oct. 30, 2008
(86) PCT No.: PCT/US08/81838

§ 371 Date: Jul. 19, 2010

Related U.S. Application Data
(60) Provisional application No. 60/984,087, filed on Oct. 31, 2007.

(51) Int. Cl. B63B 35/81; C08J 3/20; B05D 1/36; C09D 127/18; A63C 5/12; B65D 77/00

(52) U.S. Cl. 441/68; 523/351; 427/407.1; 524/546; 280/610; 206/579

(57) ABSTRACT

An article of manufacture comprises a substrate which defines the shape of the article and which comprises a sliding surface adapted for sliding over the surface of snow or over ice or over water, which sliding surface is coated with an oxidation-resistant hydrocarbon wax coating which is long lasting and renders the sliding surface near super-hydrophobic and thus lowers the sliding drag of the sliding surface on snow, ice or water over which the substrate is adapted to be slid.

### TECHNICAL FIELD OF THE INVENTION

This invention relates to the art of articles of manufacture which have a long lasting waxed sliding surface which is near super-hydrophobic, which are adapted to slide along the surface of snow, or ice or water with minimum drag; to a volatile solvent-free method for the production of volatile solvent-free hydrophobic colloidal dispersions of colloid-sized particles of polytetrafluoroethylene (PTFE); to their use to produce volatile solvent-free hydrophobic wax compositions containing colloid-sized particles of PTFE dispersed therein; to the use of these wax compositions to produce the waxed sliding surfaces; and to a kit comprising a shaped block of a thus produced wax composition and a applicator containing a volatile-solvent free, hydrophobic surfactant, e.g., a reactive silicone, which is adapted for manually producing near super-hydrophobic waxed sliding surfaces.

### BACKGROUND OF THE INVENTION

The prior art relating to the inclusion of a poly(alpha)olefin and/or a polyfluoroalkylene (PTFE) hydrocarbon in the wax used to reduce the surface drag of sliding sports equipment, such as skis, sleds, snow-boards, etc., i.e., the friction coefficient between the equipment's sliding surface(s) and the ice or snow over which it slides, is described in U.S. Pat. Nos. 4,343,863 and 6,465,398, whose disclosures relating to such waxes and their preparation is incorporated herein by reference. U.S. Patent application 200702225179, published Sep. 27, 2007 and based on PCT/EP05/08698, filed Aug. 10, 2005, describe agents for improving the gliding properties of sports equipment, such as skis, It also describes the use of modified silicone polymers as lubricants cites earlier prior art which use paraffin waxes, fluorinated waxes and fluorinated polymers and can also contain additives. See also U.S. Published Patent Applications 20040106821, 20060052258 and 2060270570. Although some of the prior art slide waxes are capable of achieving reductions in friction coefficients and corresponding increases in hydrophobicity, and others produce a long acting waxed surface resistant to oxidation, the commercially available ski waxes do not achieve both, much less can be prepared without releasing a volatile solvent into the atmosphere during their preparation and/or their application to the sliding surface. This invention provides wax compositions which when used as a slide wax coating have a long effective life and can be prepared without the use of a volatile solvent, can impart near super-hydrophobicity to a wax coating on the sliding surface of sliding sports equipment and other substrates and which can be adapted to minimize slide drag over snows which are soft (non-compacted) or wet, over snows which are optimum for sliding sports and over snows which are compacted or icy, and to those which are adapted to slide over or through water.

### SUMMARY OF THE INVENTION

In a first article of manufacture aspect, this invention relates to an article of manufacture which comprises a substrate which defines the shape of the article and which comprises a sliding surface adapted for sliding over the surface of snow or over ice or over water, which sliding surface is coated with an oxidation-resistant hydrocarbon wax coating which is long lasting and, in a preferred embodiment, increases the hydrophobicity of the sliding surface to near super-hydrophobic, which significantly lowers the sliding drag of the sliding surface on snow, ice or water over which the article of manufacture is adapted to be slid, which wax coating comprises, in one embodiment, a homogeneous mixture of:

(a) a hydrophobic base wax layer comprising a solid intimate mixture which is free of volatile solvent and of hydroscopic ingredients of:

(i) a high end melting point hydrocarbon hard wax which has a melting point higher than optimum for producing a wax coating having an acceptable life expectancy on the sliding surface of the substrate;

(ii) a low end melting point hydrocarbon soft wax which has a melting point lower than the first hydrocarbon wax, in a weight ratio to (i) which is effective to lower the hardness of the mixture of waxes to a selected value between those of (i) and (ii) individually; which solid mixture of waxes has uniformly dispersed therein

(iii) colloid size particles of polytetrafluoroethylene (PTFE), which are uniformly distributed in (a) as discrete particles which lack the surface charge which would maintain those particles as powder sized aggregates, and whose surfaces are coated with

(iv) a hydrophobic polar film-forming liquid oil, in an amount effective to eliminate the surface charge from the surface of the colloid size discrete particles of PTFE which is present in free flowing powder sized aggregates thereof,

(v) a non-volatile inert hydrophobic oily low viscosity liquid, in an amount effective to enable a mixture of (iii) and (iv) to be converted by physical means from a heterogeneous mixture into a homogenous colloidal gel; and

(vi) optionally, one or both of a hydrophobic colored dyestuff to identify the type of snow on which the wax coated sliding surface of the article of manufacture is adapted to be used, and an odorant which imparts a pleasant odor to the slide wax composition.

In a preferred embodiment of the first article of manufacture of this invention, the wax base coating thereon (a) has over its surface and strongly bonded thereto a top layer (b) of a film of at least one a hydrophobic polar film-forming liquid which is strongly bonded to the surface of the base wax coat (a); and a gradient boundary exists between (a) and (b) formed by a portion of the liquid oily forming the film thick top layer migrating into the base coat layer.

In a second article of manufacture aspect, this invention relates to a kit for producing a near super-hydrophobic waxed coating on the sliding surface of a sliding sports equipment, which kit comprises (a) a moisture vapor impervious sealed container containing therein and removable there from (b) a solid block of a PTFE slide wax composition of this invention whose shape is adapted to facilitate manually applying as a base wax coating a layer thereof on the sliding surface; (b) and an applicator comprising a piece of fabric with interstices or of a sheet of an open celled foam which is impregnated with an oily hydrophobic low viscosity hydrophobic polar film forming liquid (c) and is adapted for applying a film of thereof as a top coat over a base coat layer of solid block (b) on the sliding surface of a sports sliding equipment, an opening (d) in container (a) adapted for removing at least (b) there from, and (e) closure means for sealing and unsealing opening (e), and wherein solid block (b) is positioned in container (a) in a first area of the interior thereof and applicator (c) is positioned in a second area thereof which is spaced apart from the first area thereof, wherein solid block (b) has a truncated conical shape whose sidewall is accordion pleated to facilitate being held while a portion of the solid block (b) is applied manually as a base wax solvent-free coating on the sliding surface of a sports sliding equipment, and applicator (c) is porous and impregnated with a hydrophobic-enhancing polar film forming liquid which is adapted for being applied with the applicator as a thin film to form a top coat layer of the waxed coating of the sliding surface of a first article of manufacture of this invention.

In one embodiment (not shown in the drawings) the kit article of manufacture aspect of this invention comprises (a) a jar with a screw top lid which contains, loosely and easily removable there from by tipping the jar upside down, a multiple use unit of the base coat wax of this invention, and which has adhered to the inner surface of the lid as described herein (b) a square of flexible open celled foam plastic, e.g., polyurethane, which is either loosely packed in the jar or a face thereof is adhered to the inner surface of the screw top lid and its opposing face extends beyond the plane of the side wall of the screw top jar so that the square can be used as an applicator to apply to a sliding surface as described hereinafter which has a layer of the base coat wax thereon, a very thin continuous film of the super-hydrophobic-creating surface thereon oily hydrophobic low viscosity hydrophobic polar film forming liquid as described herein; and (c) a plurality of units of separate individual “pillow” conventional packs or a conventional sheet of a plurality of easily separable by tearing segments, each of which segment contains a “blister” package containing a small amount e.g., from a few, e.g., two or more, drops to a few, e.g., 5 to 10 cc, of the film forming liquid, which can easily opened by cutting or tearing the encasing plastic film. In a first process aspect, this invention relates to a process for the production of a hydrophobic free flowing liquid colloidal gel of colloid size discrete particulate PTFE colloidally dispersed in an inert low viscosity hydrophobic liquid which does not contain a volatile solvent and does not contain a hydrophilic component, i.e., is moisture-free, which process comprises the steps of:

a) dry mixing a selected amount of (i) a free flowing powder sized PTFE aggregates of colloid-size particles of PTFE with (ii) an amount of a hydrophobic polar film forming liquid effective to coat the surfaces of the colloid size discrete particles of PTFE forming the aggregates and thereby eliminate the surface charge there from, (iii) an amount of an inert hydrophobic oily low viscosity liquid vehicle effective to convert the thus produced mixture into a uniformly lumpy mass;

b) subjecting the thus produced lumpy mass to high energy shearing action with an amount of a non-volatile, moisture-free inert hydrophobic oily low viscosity liquid effective to convert by mixing the thus-produced lumpy mass into a homogeneous malleable solid having a bread dough-like texture; and

c) passing the thus-produced malleable solid through a colloid milling means which converts the malleable mass into a pourable liquid thixotropic gel.

In a second process aspect, this invention relates to a process which does not employ a volatile solvent for the production of a hydrophobic sliding wax composition, which does not contain a volatile solvent and which is suitable for use as sliding wax for skis and other articles of manufacture with a sliding surface adapted to slide over snow, ice or water and to increase its hydrophobicity and reduce its sliding drag, which comprises the steps of:

a) mixing, concurrently with or after heating to its melting point a mixture of a hydrophobic hard wax composition comprising (i) a high end melting point hydrocarbon wax and (ii) a low end melting point hydrocarbon wax which can be used as such as a wax coating on the sliding surface of an article of manufacture of this invention, (iii) an amount, (iv) in an inert low viscosity oily hydrocarbon as a fluid thixotropic gel, of (v) discrete colloid size particles of PTFE the aggregates of which are fine powder size, colloidally dispersed in an inert hydrophobic liquid effective to increase the hydrophobicity of a solid coating of the wax composition on the sliding surface of a sliding article of manufacture, (vi) a hydrophobic polar surfactant which is compatible with and can form a film thereof on the surface of hydrophobic waxes, and optionally, (vii) one or both of a dyestuff which identifies the type of snow on which the wax composition performs best and an odorant which imparts a pleasant odor thereto,

c) cooling the thus-produced molten wax composition until it solidifies, and

d) applying as a wax base coat the thus-produced solid wax composition to the sliding surface of an article of manufacture adapted to slide on snow, ice or water, the solid wax composition, thereby increasing the hydrophobicity thereof and reducing the slide drag of the article of manufacture.

In a second process aspect, the step of the first process aspect of this invention of applying as a wax base coat to the sliding surface of an article of manufacture of this invention is followed by the step of applying over the wax base coat as a top coat thereon a film of a fluid hydrophobic polar film forming liquid which is compatible with and can form a film thereof on the surface of the hydrophobic waxes and forms a strong bond with the surface of the wax base coat and a portion thereof migrates in the wax base coat to form a gradient boundary there between.

In a composition of matter aspect, this invention relates to a hydrophobic viscous liquid thixotropic gel which is free of any hydrophilic ingredient and free of volatile solvent and which consists essentially of a colloidal dispersion of colloid sized particles of PTFE dispersed homogeneously in an inert low viscosity hydrophilic oily liquid and which also contains as a coating on the colloid size particles a fluid hydrophobic polar film forming liquid which is compatible with and can form a film thereof on the surface of the hydrophobic waxes and thereby eliminate there from the surface e charge which maintains a free flowing powder sized particulate PTFE as aggregates of the colloid sized particles.

In another composition of matter aspect, this invention relates to a solid wax composition adapted for application of a coating thereof to the sliding surface of an sliding article of manufacture which comprises, uniformly dispersed in a solid hydrophobic wax substrate which is free of volatile solvent and any hydrophilic ingredient, discrete colloid sized particles of polytetrafluoroethylene (PTFE) whose surface lack the surface charge which maintains free flowing powder sized particulate PTFE as aggregates of colloid sized particles thereof.

### THE DRAWINGS

FIG. 1 is a flow chart which summarize process steps, equipment and ingredients which can be employed in accordance with this invention to produce slide waxes containing dispersed therein colloid-sized discrete particles of PTFE;

FIG. 2 is a overhead partial view of a multiple cavity mold 1 containing in each cavity thereof a removable insert 2 with an accordion pleated side wall 4 for forming in each thereof a solid base wax unit 3 of this invention, one of which 5 is shown with a solid wax unit 3 therein;

FIG. 3 is an overhead reduced view of an insert 2 showing the pleated interior face 4 of its side wall and its flat bottom 6; and

FIG. 4 is an overhead reduced size view of a solid wax unit 3 with an accordion pleated side wall 4, positioned upside down to show its flat bottom face 7, after being formed as a molten liquid form in a cavity of mold 1 containing an insert 2, cooled to a solid base wax unit 3 and thereafter separated from the insert 2 in which it was formed.

### DETAILED DESCRIPTION OF THE INVENTION

A critical element of this invention was the discovery that the presence of powder size particulate polytetrafluoroethylene (PTFE) in ski waxes have little if any effect on the hydrophobicity of the sliding surface of sliding sports equipment and thus slide drag achieved by a corresponding ski wax which lacks the PTFE. To overcome this anomaly, it was necessary to first convert the commercial form of PTFE from powder size aggregates thereof to discrete colloid-sized particles thereof which are colloidally dispersed in a hydrophobic low viscosity inert liquid which lacks any hydroscopic ingredient and is free of volatile solvent and can be used to incorporate colloid size PTFE particles into a ski wax composition by conventional means without the use of a volatile solvent and retaining their discrete colloid physical state. This is accomplished by converting particulate PTFE from a commercially available finely divided dry powder sized aggregates of colloid size particles of PTFE into a thixotropic hydrophobic gel of colloid size discrete particles of PTFE dispersed in a hydrophobic volatile solvent-free oily inert liquid by:

mixing the powdered PTFE aggregate particles with an amount of a hydrophobic volatile solvent-free oily non-aqueous liquid which is effective to produce a uniformly lumpy heterogeneous solid which lacks a discrete liquid phase;

subjecting a mixture of the thus produced lumpy solid and an amount of an inert anhydrous oily low viscosity liquid which is effective with high shear energy mixing to transform the lumpy solid mixture into a malleable solid mass which although it lacks volatile solvent is sufficiently malleable that it can be converted into a homogeneous thixotropic pourable gel by passing it through a colloid mill. The use of this hydrophobic, i.e., moisture-free, gel instead of a conventional particulate PTFE dry powder alone or suspended in a volatile solvent, improves significantly the hydrophobicity and thus the reduction in sliding friction which cannot be achieved with otherwise conventional hydrocarbon ski wax compositions by incorporating therein a corresponding amount of particulate powder size PTFE.

Another critical aspect of this invention was the discovery that not only the permanence of the increase in hydrophobicity achieved by the presence of colloid size particulate PTFE in the base wax coat improved, an increase thereof to near super-hydrophobic level can be achieved by the presence not only in the base wax coat of at least one and preferably more than one fluid hydrophobic polar surfactant as a coating on the surface of the discrete particles of the PTFE in the hydrophobic waxes but its presence as a top coat of film thickness over the base wax coat. The step of applying onto the sliding surface of a ski which is coated with a base wax coating a film of a liquid hydrophobic polar surfactant as defined herein is not conventional commercially and is believed to be a novel concept.

An environmentally important aspect of the present invention is the fact that all of the objectives thereof can be achieved without the use of any volatile solvents.

Examples of specific aspects of the first article of manufacture aspect of this invention are one or more of the following:

a. the substrate with a sliding surface is a sliding sport equipment adapted for use on snow.

b. the substrate with a sliding surface is a snow ski.

c. the substrate is adapted for use on the surface of water, e.g., a water ski or water board, or through water, e.g., the outer surface of a kayak, row boat or sail boat or of a submergible vehicle or device.

d. the substrate is an article of swimming or diving clothing, e.g., one formed from a sheet of natural or synthetic rubber or from a flexible woven fabric which, when a sliding wax of this invention is applied while heated to the surface thereof and then allowed to cool, produces a hydrophobic layer on that surface which is waterproof.

Examples of compositional aspects of the base wax coatings produced in accordance with this invention and the intermediate products from which they are produced are:

a. The weight percentage ratio of free flowing powder aggregates of polytetrafluoroethylene (PTFE) to the low viscosity polar film forming surfactant liquid used to eliminate the surface charge on the colloidal sized particles forming the aggregates can range from about one % to about 5%, preferably from about 1.5% to about 1.8%.

b. The weight percentage ratio of the starting PTFE solids to the low viscosity inert liquid used to convert aggregates of PTFE whose colloid particles are coated with a low viscosity polar film-forming surfactant liquid to a homogeneous malleable solid which can be passed through a colloid mill can range from about 50% to about 70%, preferably from about 30% to about 40%.

c. The weight percentage of the gel of the PTFE solids in the low viscosity inert liquid which is mixed with the solid base waxes can range from about 10% to about 60%, preferably from about 30% to about 40%.

Whether a fluid hydrophobic polar film forming liquid, such as a silicone, has surfactant activity and thus suitable for use as a top coat over a base wax coating on the sliding surface of an article of manufacture according to this invention can be determined qualitatively by partially filling a warmed glass jar with a candidate silicone and the jar shaken vigorously. Even if only a few bubbles appear, the requisite surfactant activity exists.

The degree of the hydrophobicity imparted to a sliding surface coated according to this invention by a conventional mixture of sliding surface waxes, by the presence therein of particulate PTFE all or substantially all, e.g., 90% or higher, of which are in the form of discrete colloid-sized particles whose surface is coated with a fluid hydrophobic polar liquid which has eliminated the surface charge on the particles and thereby maintained the PTFE in discrete particles form in that mixture of waxes, compared to the corresponding mixture of sliding surface waxes in which the PTFE is in the form of aggregates of the PTFE particles, can be determined by forming side-by-side parallel strips of a wax base coating formed on a smooth face of a rectangular piece of natural wood board or rigid plastic laminate sheet using (a) using only the sliding surface wax or waxes, (b) a mixture of the same wax or waxes and aggregates of colloidal-sized PTFE particles, and (c) a mixture of the same wax or waxes and discrete colloidal-sized PTFE particles whose surface lacks the surface charge which maintains the particles as aggregates thereof. Slant the board or sheet at a slight angle from its horizontal position with the strips of base wax running from top to bottom of the test board or sheet; apply a drop of pure water at the upper end and determine how long the drop retains its globular shape and how long it takes to run off the lower end of the test board or sheet. Repeat this test with the test board at increasing angles from the vertical on each of the three strips of wax base coats. The greater the hydrophobicity of the wax base coat, the longer the drop of water will retain its globular shape and the quicker it will reach the bottom end of the test board or sheet. The results will typically show that the test strip whose waxed surface is formed from a mixture of conventional waxes containing particulate PTFE in the form of aggregates distributed uniformly therein typically has a hydrophobicity which does not differ significantly from that of the test strip coated with a ski wax formed from the corresponding mixture of waxes alone. In contradistinction, the results obtained with a wax base coating thereon according to this invention containing the same amount of particulate PTFE as discrete colloidal-sized particles whose surfaces lack a surface charge, have a significantly higher level of hydrophobicity.

The sliding surface of an article of manufacture according to this invention has thereon a wax base coat which (a) contains PTFE colloidal-sized particles which predominantly, e.g., at least about 90%, preferable at least 95%, more preferably at least 99.5% and most preferable at least about 99.9%, i.e., substantially completely in the form of discrete particles rather than as aggregates thereof In its near “super-hydrophobic” state, the wax base coat has covering the surface thereof a film of substantially uniform thickness of at least one oily hydrophobic polar film-forming liquid which is strongly bonded to the surface of the base coat and which forms a gradient boundary between it and the wax coat bottom layer, typically has a hydrophobicity which is near super-hydrophobic, i.e., near the maximum theoretically possible if the surface of the wax base coat were frictionless.

The term “near super-hydrophobic” as used herein means that in an end use environment the rate of slowing of a sliding surface as defined herein coated with a base wax composition top coated as described herein is only negligibly greater than that of a corresponding a hypothetical frictionless sliding surface because of other rate of slide slowing factors, e.g., air resistance, reduced air pressure between the sliding surface and the texture of the surface of the snow, the combined weight of the article of manufacture and the human using it and the rate and frequency of change of direction of the sliding surface over the show or ice. As described herein, the nearness to a frictionless state imparted to the sliding surface of the substrate of an article of manufacture of this invention or, for that matter any flat smooth surface, by the method and wax coating composition of this invention, can be observed by the increase in the distance that a drop of water can travel on a slightly sloped positioned, smooth flat surface which is coated with a top coated base wax composition of this invention, before its globular shape disintegrates or the speed at which it takes the drop of water to reach the end of that surface, compared to corresponding smooth flat surface which has been coated with a conventional commercial ski wax, irrespective of whether it contains or does not contain powder PTFE.

As with conventional base coat waxes adapted for skiing, both lacking and containing aggregates of colloidal particles of PTFE, for optimum performance, a mixture of at least one “high end” high melting point wax and at least one “low end” lower melting point wax is used in a weight ratio which provides optimum hardness and surface coefficient of friction with respect to the characteristics of the snow to be skied upon and thus, optimum sliding performance. Hardness of the wax base coating of this invention (with and without a surface coat on the surface thereof as described herein) and, for comparison, with the same article of manufacture whose sliding surface has a conventional wax base coat thereon can be determined conventionally using a durometer, e.g., PTC Instruments (Los Angeles, Calif.) Model 408 ASTM type. (A testing device with a tiny plunger protruding from the flat face of a plate and which has a dial which displays a numerical value of the force required to press the tip of the plunger through the wax coating on a flat sliding surface and no longer protrudes from the plane of the flat face of the plate.)

Examples of preferred aspects of the process for producing a first article of manufacture of this invention are one or more of the following:

a. The starting powder size polytetrafluoroethylene (PTFE) aggregates are preferably micronized and have an average particle side of less that 5 μm, preferably about 2-4 μm, e.g., Agloflon® L 101-1 and L101X, Solvay Solex).

b. The hydrophobic surfactant, e.g., a reactive silicone oil, used to coat the surface of the individual colloid sized particles of PTFE in the powder size aggregates which are mixed with a slide wax or the waxes as starting materials for a process aspect of this invention, are “intermediate” polysilicones having a substituent which renders them reactive to the hydroxyl group of water and of organic compounds and with saturated polyesters or polyalkyds to form a silicone polyester copolymer, e.g., Dow Corning® 3037 “Intermediate” and MH1109 Fluid, a siloxane which reacts with the hydroxyl groups of organic and inorganic substrates.

c. The inert low viscosity hydrophobic oil used to disperse the individual colloidal sized PTFE dispersion of the discrete colloid sized particles into a melt of the solid waxes used in this invention is preferably a low viscosity polar film forming liquid hydrocarbon, more preferably a mono-unsaturated hydrocarbon, e.g., a poly(alpha)-olefin, e.g., “PAO 4cts” (Chevron Phillips) “Vistone A30” (Infineum Corp.) or an inert hydrocarbon ester, e.g., ditridecyl adipate.

d. The starting solid particulate polytetrafluoroethylene (PTFE) incorporated as a uniform dispersion in the solid waxes used in this invention are finely divided powder size aggregates of colloidal sized PTFE particles, e.g., “Polymist F-5A” (Ausimont USA), “Algoflow “L-101-1” and “L-203” (Solvay Solexus), “Fluoro E” and “SST-4MG” (Shamrock).

e. The sliding surface base coat wax ordinarily is a mixture of solid waxes, e.g., those used to conventionally to produce a base wax coat on the sliding surface of a first article of manufacture of this invention, e.g., a bottom face of a ski, and are preferably hydrocarbons, more preferably a mixture of a hard microcrystalline wax, e.g., with a high end m.p. (e.g., 175-200° F.), e.g., “SH 105” (DeGussa GMBGH), “BW-408”, “BW-435” “BW-430”, BW-429” and “BW-431 (Blended Waxes, Inc.). and a soft wax, e.g., with a low end m.p. (e.g., 135-155° F.), e.g., “A118” (DeGussa GMBGH), “BW-422”, “BW-436” and “BW-440” (Blended Waxes, Inc.).

Examples of preferred aspects of the second article of manufacture aspect of this invention are one or more of the following:

a. The container is a conventional cylindrical glass or hard inert plastic jar with a vertical side wall whose exterior surface is threaded at its top end around its open mouth and an internally threaded metal or hard inert plastic cap configured to be screwed onto the jar and seal it.

b. The size of the unit of the solid base coat wax composition permits multiple uses thereof to coat a sliding surface of an article of manufacture of this invention.

c. The size of the container enables the unit of solid base coat wax composition therein to rest loosely in the bottom portion of the container and to be easily removed from the container simply by shaking the opened container while upside down.

d. The applicator used to apply a film thickness top coat over the base wax coat is a sheet of an open small celled sponge, e.g., a square of a sheet of open celled polyurethane foam, which is positioned in the interior of the screw cap of the container and maintained in that position by friction and adapted to be removed from the container and separated from the container's cap when applying the film thick top coat over the base coat of a sliding surface or bonded to the interior surface of the top of a cap for the container with a face thereof which extends beyond the side wall of the cap when adapted to be used for such purpose while holding the cap.

e. The side wall of the cavities mold employed in Step d) are smooth and are inverted truncated cone shaped with a flat instead of pointed bottom face, i.e., the face used to apply the base coat wax to the sliding surface.

f. The hot flowable wax formulation is poured into the cavities of a mold having a plurality of cavities whose walls have a non-stick surface or have a paper or high melting (above that of the hot wax formulation) plastic inserts therein whose dimensions permit the fluid mixture when hardened in the cavities to be removed easily from the mold.

g. The paper or high melting plastic inserts are cupcake shaped with an accordion side wall, as shown in the drawings, and, when the molten wax has hardened, cup cake shaped units of the base coat wax formulation of this invention are produced which are easily held when manually applying a coat thereof onto the bottom of a ski or the sliding surface of other sliding sports equipment. The base wax units are easily separated from the inserts when the latter is formed of a flexible silicone rubber or from paper whose inner surface is coated or impregnated with “Teflon®” or is coated or impregnated with an inert polymer which facilitates peeling the plastic insert from a cup cake shaped unit prior to use.

### SPECIFIC EXAMPLES OF THIS INVENTION

### Example 1

### Method for the Preparation of a Colloidal Dispersion of Polytetrafluoroethylene (PTFE) in a Non-Volatile Low Viscosity Liquid Hydrophobic Hydrocarbon

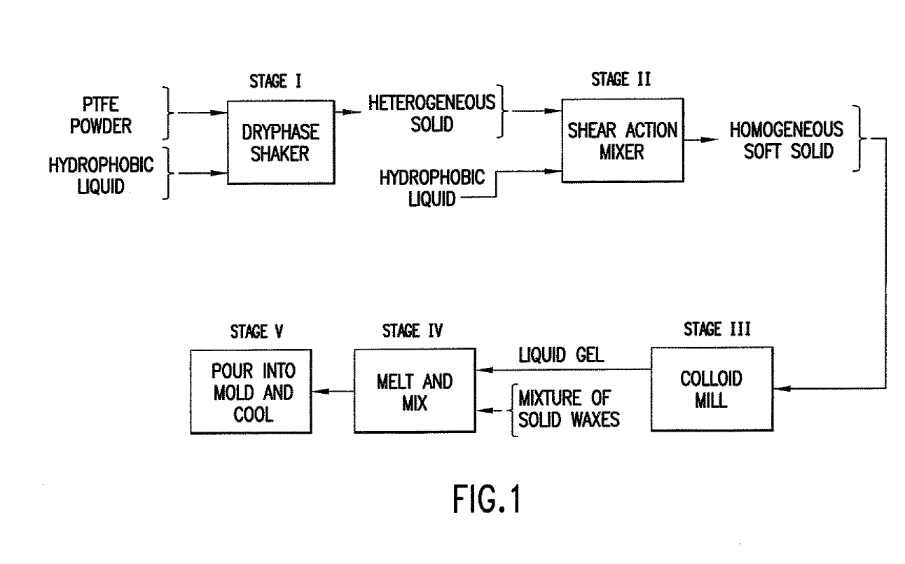

In a one gallon can, dry mix (“Stage I” of FIG. 1 of the drawings) by high speed shaking 2.2 lbs. of “Algoflow” L-101-1, a commercially available free flowing PTFE powder size aggregates of colloid particles of PTFE with 200 cc of a 50:50 mixture of the reactive silicones Dow Corning 3037 and Dow Corning BH 109 sufficient to coat the surface of the colloid sized PTFE particles present in the aggregates thereof which convert the sta (the starting PTFE for Stage 1), until a lumpy solid (the product of Stage I of the drawings) is produced but less than the amount which leaves visible liquid as a separate phase admixed therewith;

convert the thus produced lumpy product into a homogeneous solid mass (the product of “Stage II” of FIG. 1) which is malleable enough to be passed through a colloid mill by high energy shearing mixing (using, e.g., Epinbach Machinery high shear mixer) with an amount of inert oily liquid hydrophobic olefin (the hydrophobic liquid used in Stage II, such 4.25 lbs of a low viscosity hydrophobic poly(alpha)olefin (PAO 4cst; Chevron Phillips) until the lumpy mixture is converted into a solid mass which has the consistency of a pastry dough and which is malleable enough to be passed through a colloid mill, and

pass the malleable solid mass through a high speed colloid mill used in “Stage III” of FIG. 1 (such as Premier) which converts it into a white pourable thixotropic gel (the product of Stage III) which has a custard-like consistency in which the PTFE colloid sized particles are discretely dispersed uniformly in the PAO.

This novel gel provides a vehicle which is free of moisture and volatile solvent which can be used to incorporate larger amounts of particulate PTFE into hydrocarbon wax formulations (“Stage IV” of FIG. 1) than those conventionally used to produce a variety of sliding waxes, including ski waxes and, surprisingly, it does so in a manner which increases one or both of the hydrophobicity imparted by the wax coating on the bottom surface of skis and the useful life thereof, significantly and surprisingly more than a corresponding wax formulation in which the same amount of powder sized particulate PTFE is incorporated into the wax formulation by dry mixing into the same wax or mixture of waxes in its dry state or as a suspension thereof in a volatile solvent.

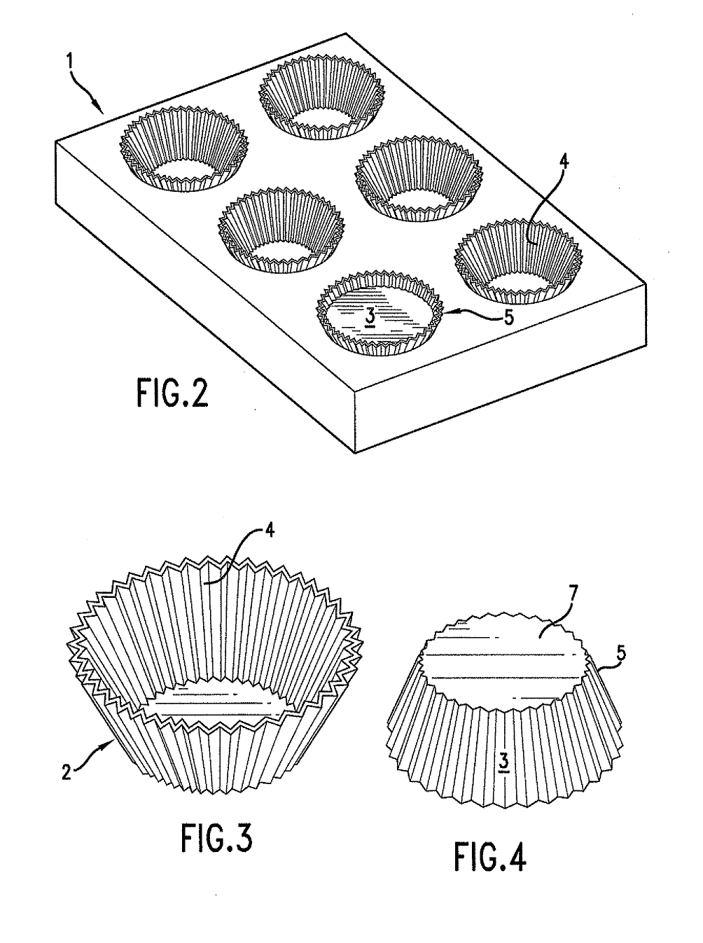

Units of solid base ski wax formulations (FIGS. 2 and 4 of the drawings) can be produced by conventional means (“Stage 5” of FIG. 1) by pouring a molten wax mixture containing uniformly dispersed therein in a mold with multiple cavities containing removable inserts formed from a high melting flexible polymer, e.g., silicone rubber or a paper impregnated with or whose inner surface is coated with a layer of a polymer which facilitates separation therefrom when the units of base coat ski wax when the molten wax composition in the inserts have cooled and solidified.

### Example 1a

Follow the procedure of Example 1 except use as the starting powder sized aggregates of colloid particles of PTFE a corresponding PTFE weight amount of “Polymist F5A” (Solvay Solexis) or a 50:50 mixture thereof and Shamrock “SST4MG” or “Shamrock Fluoro E.

### Example 1b

Follow the procedure of Example 1 except use as the reactive coating agent a corresponding amount of “Fluoro E” (8.8 lbs.) of the hydrophobic surfactant “Flurad FC 740” (3M, et al.).

### Example 2

### Production of a Sliding Wax which is Optimum for Use on Hard Packed or Icy Snow

Melt together four pounds of low end melting point hydrocarbon soft wax Degussa “GMBH A118 (M.P. 85° C.), four pounds of a high end melting point hard wax (fischer-tropsch, Degussa “GMBH SH 105” high melting 108° C. wax) and 6 pounds of the thixotropic gel of Example 1, to 220° C. and then add thereto 50 cc of a blend of BH 1109 fluid reactive silicone oil (Dow Corning Corp.) and 50 cc of DC 3037 (Dow Corning Corp.) intermediate silicone, followed by a drop or two of a hydrophobic odorant to impart a pleasant aroma to the wax formulation and one gram of a hydrophobic blue dye to identify the resulting wax as a base wax adapted for use on hard packed or icy snow.

Pour the melt into a mold with multiple cavities containing a cup cake shaped high melting flexible plastic insert as described in Example 2 in each cavity and then cool to produce multiple solid units of a ski wax of a size and side wall shape adapted to facilitate manually apply a coating thereof on the slide surface (bottom) of skis in a conventional manner as describe herein. Apply the hard wax formulation to the sliding surface of a ski in a conventional manner used for high melting waxes, i.e., with a air dryer.

### Example 3

### Production of Near Super-Hydrophobic Waxed Sliding Surface

To increase the hydrophobicity of the thus base coat waxed skis to near near-super hydrophobic level, apply a film coat of at least one of the BH 1109 fluid reactive silicone oil (Dow Corning Corp.) and DC 3037 (Dow Corning Corp.) intermediate silicone present in the wax BH 1109 fluid reactive silicone oil (Dow Corning Corp.) and 50 cc of DC 3037 (Dow Corning Corp.) intermediate silicone. The thinner and more uniform the top coat film, the greater the increase in hydrophobicity achieved by the presence of the top coat film over the wax base coat. An optimum increase can be achieved by applying a drop or two of the reactive silicone mixture on a square of a sheet of an open cell flexible compressible hydrophobic plastic, e.g., polyurethane, foam and gently wiping the face thereon to which the drop or two of reactive silicone mixture were applied across the sliding surface of an article of manufacture having a layer of the base coat wax mixture thereon. Applying an amount thereto above the optimum tends to produce a “sticky” coating with increased surface friction. The same effect is observed if only type of silicone oil is applied as a film layer or the ratio of the two is not optimum for the type of snow over which the sliding surface is slid. The values of these variables which are optimum depend on the particular environmental variables when using the thus treated sliding surface is used, including ambient temperature and humidity, the liquid water content of the snow and its physical configuration, including its depth and density and the particle shape and hardness of the snow particles. The optimum combination of the variables for the surface coat can be determined by the decrease in sliding friction and resulting decrease in sliding speed achieved on a specific day in repeated runs over a specific sliding surface in which the only variable is the composition of the reactive hydrophobic silicone oil applied as a top coat to the sliding surface.

### Example 3a

### Production of a Sliding Wax which is Optimum for Use on Intermediate Hardness Snow of Optimum Density and Texture for Skiing

Follow the procedure of Example 2 except increase the amount of A118 wax to 6 pounds and reduce the amount of SH 105 wax to two pounds and optionally add ½ gram of a hydrophobic yellow (instead of blue) dyestuff to identify the mixture as a base wax adapted for use on snow of intermediate texture and density. Apply the wax manually by rubbing it onto the sliding (bottom) surface of skis in the conventional manner.

Increase the hydrophobicity of the coating to near super-hydrophobicity by applying to the surface thereof an uniform film of at least one of the reactive silicones present in the base coat, preferably and more conveniently, the same one or ones.

### Example 4

### Preparation of a Ski Wax for Use on Soft or Wet Snow

Follow the procedure of Example 2 except increase the amount of A118 wax to 7 pounds, omit the SH 105 wax and optionally add ½ gram of a red (instead of blue) dyestuff to the melted wax mixture to identify the wax mixture as a base coat wax adapted for use on soft snow. Apply a coating of the wax mixture manually by rubbing it onto the sliding (bottom) surface of skis in the conventional manner used to produce a wax base coat.

Increase the hydrophobicity of the coating to near super-hydrophobicity by applying to the surface thereof a film thickness layer which is as thin and as uniform as can be achieved conveniently by manual application of at least one of the reactive silicones present in the base coat, preferably and more conveniently, the same one or ones.

What is claimed is:

1. An article of manufacture which comprises a substrate which defines the shape of the article and which comprises a sliding surface adapted for sliding over the surface of snow or over ice or over water, which sliding surface is coated with an oxidation-resistant hydrocarbon wax coating which is long lasting and renders the sliding surface near super-hydrophobic and thus lowers the sliding drag of the sliding surface on snow, ice or water over which the substrate is adapted to be slid, which wax coating comprises a homogeneous solid mixture of:
(a) a hydrophobic base wax layer comprising a solid intimate mixture which is free of volatile solvent and hydroscopic ingredients of:
(i) a high end melting point hydrocarbon hard wax which has a melting point higher than optimum for producing a wax coating having an acceptable life expectancy on the sliding surface of the substrate;
(ii) a low end melting point hydrocarbon soft wax which has a melting point lower than the first hydrocarbon wax, in a weight ratio to (i) which is effective to lower the hardness of the mixture of waxes to a selected value between those of (i) and (ii) individually; which solid mixture of waxes has uniformly distributed therein;
(iii) colloid size discrete particles of polytetrafluoroethylene (PTFE), which are uniformly distributed in (a) as discrete particles whose surfaces lack the surface charge which otherwise maintain colloid size PTFE particles as powder size aggregates thereof and the surface of which colloid size particles is coated with
(iv) a hydrophobic polar film forming liquid, in an amount effective to maintain the surfaces of the colloid size discrete particles of PTFE therein free from the surface charge present on the surfaces of such discrete particles of PTFE in free flowing powder sized aggregates thereof; and
(v) a non-volatile inert hydrophobic oily low viscosity liquid vehicle, and
(vi) optionally, one or both of a hydrophobic colored dyestuff to identify the type of snow on which the wax coated sliding surface of the article of manufacture is adapted to be used, and an odorant which imparts a pleasant odor to the slide wax composition.

2. An article of manufacture of claim 1, wherein the wax coat has over its surface and strongly bonded thereto, a film thickness top coat layer of at least one oily hydrophobic polar film-forming liquid which is strongly bonded to the surface of the base coat and which forms a gradient boundary between it and the wax coat bottom layer and the top coat layer.

3. An article of manufacture of claim 2, which is a snow ski.

4. In a second article of manufacture aspect, this invention relates to a kit adapted for producing a near super-hydrophobic wax coating on ,the sliding surface of a sliding sports equipment of claim 1, which kit comprises (a) a moisture vapor impervious sealed container containing in one position of the container and removable there from (b) a solid block of a homogeneous spreadable solid slide wax composition according to claim 1, whose shape is adapted to facilitate manually applying the slide wax composition as a base wax coating a layer thereof on the sliding surface of a sliding sports equipment; and, spaced apart from the solid block (b), (c) an applicator comprising a piece of fabric with interstices or of a sheet of an open celled foam, which is impregnated with (d) an oily hydrophobic low viscosity liquid surface active polar film forming liquid, which applicator is adapted for applying a film of (c) as a top coat layer over a base coat layer of solid block (b) on the sliding surface of a sports sliding equipment, an opening (e) in container (a) adapted for removing at least (b) therefrom, and (f) closure means for sealing and unsealing opening (e), and wherein solid block (b) is positioned in container (a) in a first area of the interior thereof and applicator (c) is positioned in a second area thereof which is spaced apart from the first area thereof, wherein solid block (b) has a truncated conical shape whose sidewall is accordion pleated to facilitate being held while a portion of the solid block (b) is applied manually as a base wax solvent coating on the sliding surface of a sports sliding equipment, and applicator (c) is porous and impregnated with a hydrophobic-enhancing liquid oily reactive silicone which is adapted for being applied with the applicator as a thin film to form the a top coat layer of the waxed coating of the sliding surface of an article of manufacture of claim 1.

5. A process for the production of a hydrophobic free flowing liquid colloidal gel of colloid size discrete particulate PTFE which lack a surface charge and which are colloidally dispersed in an inert low viscosity hydrophobic liquid, which does not contain a volatile solvent and does not contain a hydrophilic component, and adapted when mixed with and heated to a molten mixture thereof and waxes formulated for use as a base wax coat on the sliding surface of an article of manufacture of claim 1, produces a base wax coated sliding surface which is more hydrophobic and longer lasting than a corresponding base wax coated only with the waxes, which process comprises the steps of:
a) thy mixing a selected amount of a free flowing powder sized PTFE aggregates of colloid-size particles of PTFE with an amount of hydrophobic film forming polar liquid surfactant effective to coat the surface of the colloid size particles of PTFE in the powder sized PTFE aggregates therewith and eliminate the surface charge on the particles and convert the mixture into a lumpy heterogeneous mass;
b) subjecting to high energy shearing action a mixture of the lumpy heterogeneous mass and an amount of a non-volatile, moisture-free inert hydrophobic oily low viscosity liquid effective to convert the thus-produced lumpy mass into a homogeneous malleable solid having a bread dough-like texture; and
c) passing the thus-produced malleable solid through a colloid milling means which converts the malleable mass into a pourable liquid thixotropic gel of the discrete particles.

6. A kit for producing a near super-hydrophobic wax coating on the sliding surface of a sliding sports equipment of claim 1, which kit comprises (a) a moisture vapor impervious sealed container containing therein (b) a solid block of a wax composition of this invention whose shape is adapted to facilitate manually applying as a base wax coating a layer thereof on the sliding surface of a sports sliding equipment, and an applicator (c) which contains an oily hydrophobic liquid silicone (d) and is adapted for applying a film of silicone (d) as a top coat over a base coat layer of solid block (b) on the sliding surface of a sports sliding equipment, an opening (e) in container (a) adapted for removing (b) and (c) therefrom, and (f) closure means for sealing and unsealing opening (e), and wherein solid block (b) is positioned in container (a) in a first area of the interior thereof and applicator (c) is positioned in a second area thereof which is spaced apart from the first area thereof, wherein solid block (b) is truncated conical shaped and whose sidewall is accordion pleated to facilitate being held while a portion of the solid block (b) is being applied manually as a base wax solvent coating on the sliding surface of a sports sliding equipment, and applicator (c) is porous and impregnated with a hydrophobic-enhancing liquid oily reactive silicone which is adapted for being applied with the applicator as a thin film to form the a top coat layer of the waxed coating of the sliding surface of a first article of manufacture of this invention.

7. A method which does not employ a volatile solvent for the production of a hydrophobic gel which does not contain a volatile solvent and which is as a vehicle for incorporating a larger than conventional amount of particulate polytetrafluoroethylene (PTFE) into a hydrocarbon wax composition which is adapted for application to the sliding surface of a ski or other sports sliding equipment according to claim 1 to increase the hydrophobicity and reduce the sliding drag thereof, which gel is a uniform dispersion of colloid size discrete particles of PTFE which lack a surface charge in a hydrophobic low viscosity oily hydrocarbon, which comprises the steps of:
a) mixing a selected amount of a free flowing PTFE powder whose particles are aggregates of colloid-size individual particles of PTFE, with an amount of an oily liquid moisture-free hydrophobic polar film forming reactive compound sufficient to coat the surfaces of the colloid size particles of PTFE in the powder aggregates therewith and effective to remove the surface charge on the colloid-size particles and convert the thus produced mixture of those aggregates and the oily liquid into a lumpy heterogeneous mass;
b) mixing with high energy shearing action the thus produced lumpy mass of coated individual particles of PTFE with an amount of a non-volatile, moisture-free inert hydrophobic oily low viscosity liquid effective to convert the thus-produced lumpy mass into a homogeneous malleable solid having a bread dough-like texture; and
c) passing the thus-produced malleable solid through a colloid milling means which converts the malleable mass into a pourable liquid thixotropic gel.

8. A process which does not employ a volatile solvent for the production of a sliding wax composition which does not contain a volatile solvent and is suitable for use as sliding wax for skis and other articles of manufacture with a sliding surface adapted to slide over snow, ice or water to increase its hydrophobicity and reduce its sliding drag, which comprises the steps of:
a) mixing an amount of a pourable liquid hydrophobic thixotropic gel of discrete colloidal particles of a solid polytetrafluoroethylene (PTFE) in an inert hydrophobic liquid hydrocarbon of with a mixture of a hard wax having a high end melting point microcrystalline wax and a low end melting point hydrocarbon wax with heating sufficient to melt the mixture and which when cooled to a solid adapted for use as the base coat wax on the sliding surface of a sliding article of an article of manufacture of claim 1;
b) adding to the thus obtained melted wax mixture prior to, concurrently with or after the addition of the colloidal gel thereto, an amount of either a hydrophobicity-enhancing liquid oily surfactant or a silicone oil which has a reactive functional group and, optionally, one or both of a dyestuff which identifies the type of snow on which the wax composition performs best; and an odorant which imparts a pleasant odor thereto,
c) cooling the -produced molten wax composition until it solidifies, and
d) applying the thus-produced solid wax composition to the sliding surface of an article of manufacture adapted to slide on snow, ice or water effective to form a coating thereon of the solid wax composition which increases the hydrophobicity thereof and reduces the slide drag of the article of manufacture.

9. A process according to claim 8 wherein the step of applying the solid wax composition to the sliding surface of an article of manufacture is followed by the step of applying over the coating a film of a film forming polar surfactant which increases the hydrophobicity of the wax coating to near super-hydrophobic state.

10. A hydrophobic pourable liquid thixotropic gel which does not contain a volatile solvent and which consist essentially of colloid sized particles whose surface lacks a surface charge of a solid particulate PTFE, colloidally dispersed homogeneously as discrete particles in a low viscosity hydrophobic inert liquid.

11. The gel of claim 10 wherein the inert liquid is a poly(alpha)olefin.
